(19) United States
(12) Patent Application Publication
(10) Pub. No.: US 2024/0281428 A1
(43) Pub. Date: Aug. 22, 2024

(54) Energy Efficient Computations of Attention-based Inferences

(71) Applicant: Micron Technology, Inc., Boise, ID (US)

(72) Inventors: Saideep Tiku, Folsom, CA (US); Febin Sunny, Folsom, CA (US); Shashank Bangalore Lakshman, Folsom, CA (US); Poorna Kale, Folsom, CA (US)

(21) Appl. No.: 18/414,782

(22) Filed: Jan. 17, 2024

Related U.S. Application Data
(60) Provisional application No. 63/485,461, filed on Feb. 16, 2023.

(51) Int. Cl. G06F 16/22; G06F 16/242

(52) U.S. Cl. CPC G06F 16/2282; G06F 16/242

(57) ABSTRACT

An apparatus to compute an attention matrix implementing an attention mechanism in artificial neural networks, having: memory to store key value pairs; a reorder buffer to provide a reordered list of keys from the key value pairs; an analog dot product accelerator configured to compute dot products of key elements of keys from the reordered list of keys with respective query elements of a query row of a query matrix; a processing device configured to generate, based on results of the dot products, a row of attention scores corresponding to the query row of the query matrix for the reordered list of keys; and a further accelerator configured to compute dot products of segments of the attention scores with value elements of respective segments of values from a list of values from the key value pairs to generate an attention matrix.

### RELATED APPLICATIONS

The present application claims priority to Prov. U.S. Pat. App. Ser. No. 63/485,461 filed Feb. 16, 2023, the entire disclosures of which application are hereby incorporated herein by reference.

### TECHNICAL FIELD

At least some embodiments disclosed herein relate to reduction of energy usage in computations in general and more particularly, but not limited to, reduction of energy usage in computations of attention scores.

### BACKGROUND

Many techniques have been developed to accelerate the computations of multiplication and accumulation. For example, multiple sets of logic circuits can be configured in arrays to perform multiplications and accumulations in parallel to accelerate multiplication and accumulation operations. For example, photonic accelerators have been developed to use phenomenon in optical domain to obtain computing results corresponding to multiplication and accumulation. For example, a memory sub-system can use a memristor crossbar or array to accelerate multiplication and accumulation operations in electrical domain.

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 shows an attention matrix calculator configured to reduce energy usages via reordering inputs to an analog accelerator according to one embodiment.

FIG. 2 shows an analog accelerator implemented using microring resonators for an attention matrix calculator according to one embodiment.

FIG. 3 shows another accelerator implemented using microring resonators for an attention matrix calculator to one embodiment.

FIG. 4 shows an example computing system with an attention matrix calculator according to one embodiment.

FIG. 5 shows a method to compute an attention matrix according to one embodiment.

### DETAILED DESCRIPTION

At least some embodiments disclosed herein provide techniques of reducing the energy expenditure in computations of attention scores via changing the order of inputs provided to analog accelerators.

Some artificial neural networks are configured with attention mechanisms to emulate human cognitive attention in selectively focusing on sub-components of information while ignoring less relevant sub-components. Transformer models employed for natural language processing (NLP) applications can contain tables of millions of key-value pairs; and computations for implementing the attention mechanisms can consume a significant amount of energy.

In general, an attention mechanism uses a query against the key-value pairs to generate a measure of attention. Each key in the key-value pairs can have a predetermined number of components as key elements; and each query has the same predetermined number of components as query elements. The dot product (multiplication and accumulation) between the components of the key and the corresponding components of the query provides a similarity score that is indicative of the similarity between the query and the key. The dot products between the key and the list of keys in the key-value pairs provide a list of similarity scores of the query with the list of keys respectively. The similarity scores of the query can be optionally scaled (based on a dimension size of the keys), and then transformed and normalized (e.g., via a softmax function) to generate a list of attention scores of the query for the list of keys respectively. Each value in the key-value pair can have another predetermined number of components as value elements. The list of attention scores of the query for the keys can be used as weights against a component of the corresponding values in the key-value pairs. A dot product between the attention scores of a query and a respective component of the values in the key-value pairs provides a respective component of attention for the query. The dot products between the attention scores and the list of values in the key-value pairs provide a measure of attention having a number of components of attention for the query, same as the predetermined number of components of each value in the key-value pairs. A plurality of queries can be formatted as a query matrix with each row containing the query elements of a separate query. Measures of attention can be computed for the plurality of queries separately to form an attention matrix having a plurality of rows of attention elements for the plurality of queries respectively.

The computation of similarity scores is a heavily parallel operation; and multiplications in the dot product can be carried out in different orders without affecting the result.

When the dot product is accelerated via an analog accelerator (e.g., implemented via microring resonators), the order in which multiplications in the dot product are carried out can have a significant impact on the amount of energy consumed in performing the dot product.

To minimize the energy expenditure of the analog accelerator in computing the attention matrix, the columns of keys can be reordered (e.g., in a descending order) in generating inputs to the analog accelerator. Reordering of the column of keys can reduce or minimize the changes in the states of computing elements of the analog accelerator (e.g., microring resonators) during the performance of the dot product between the query matrix and the key column, which can reduce or minimize the energy expenditure associated with the state changes of the computing elements and thus the energy expenditure of the analog accelerator in computations of an attention matrix.

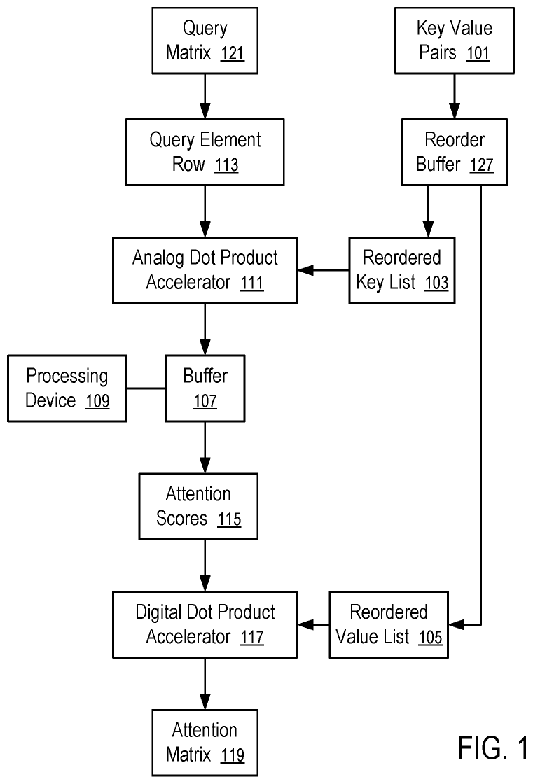

FIG. 1 shows an attention matrix calculator configured to reduce energy usages via reordering inputs to an analog accelerator according to one embodiment.

The attention matrix calculator of FIG. 1 is configured to generate an attention matrix 119 for a query matrix 121 based on a set of key value pairs 101.

The attention matrix calculator of FIG. 1 has an analog dot product accelerator 111. The amount of energy expenditure of the analog dot product accelerator 111 can be dependent on the order of inputs provided to the analog dot product accelerator 111.

When a computing element (e.g., a microring resonator) in the analog dot product accelerator 111 transits between performing a multiplication with a current element in the key list 103 and performing a multiplication with a subsequent element in the key list 103, an amount of energy is used to change the state of the computing element. Such an amount of energy for state change can be reduced or minimized by selecting the subsequent element to have a reduced or minimized difference from the current element.

To reduce the energy consumption of the analog dot product accelerator 111 in generating the attention matrix 119, the attention matrix calculator of FIG. 1 can be configured to use a reorder buffer 127 sort the key list 103 in a descending order, an ascending order, or another order that reduces or minimizes the differences between adjacent sets of key components of keys from the list 103 provided to the analog dot product accelerator 111 as inputs.

In response to the query matrix 121, the attention matrix calculator of FIG. 1 can retrieve a row 113 of query elements of a query from the query matrix 121 to perform a dot product between the query and each key in the reordered key list 103.

For example, for each row 113 of query elements of a query in the query matrix 121, the analog dot product accelerator 111 can perform the multiplication and accumulation of query elements with corresponding key elements of each respective key from the reordered key list 103 and provide a result of the multiplication and accumulation in the buffer 107 as a similarity score between the query and the respective key. Optionally, the similarity scores corresponding to the list 103 of the keys can be further scaled (e.g., based on a dimension size of the key list) by the processing device 109 or the analog dot product accelerator 111. The similarity scores, optionally scaled, can be further transformed (e.g., via an exponential function as in softmax) and normalized (e.g., via a softmax function) by the processing device 109 to generate a column of attention scores 115 for the query represented by a row of query elements in the query matrix 121.

A digital dot product accelerator 117 of the attention matrix calculator can use each attention score 115 to weigh a value in the value list 105 to generate a weighted sum of the values as a measure of attention. In general, each value in the value list 105 can have a predetermined number of components as value elements; and each component of the value list 105 can be weighted separated according to the list of attention scores 115 of a query to generate a component of the measure of attention for the query. The components of the measure of attention for the query form a row of attention elements in the attention matrix 119 for the query. For example, a set of logic circuits can be configured to perform the dot product between a segment of the attention scores 115 for a query and a corresponding segment of values in the list 105; and the digital dot product accelerator 117 can further accumulate the result of the dot product with the prior result of dot product performed between the prior segment of the attention score 115 and the corresponding prior segment of values. Optionally, the analog dot product accelerator 111 (or a similar analog accelerator) can be further configured to perform the dot product operation to generate the row of attention elements in the attention matrix 119 for the query, as discussed further below.

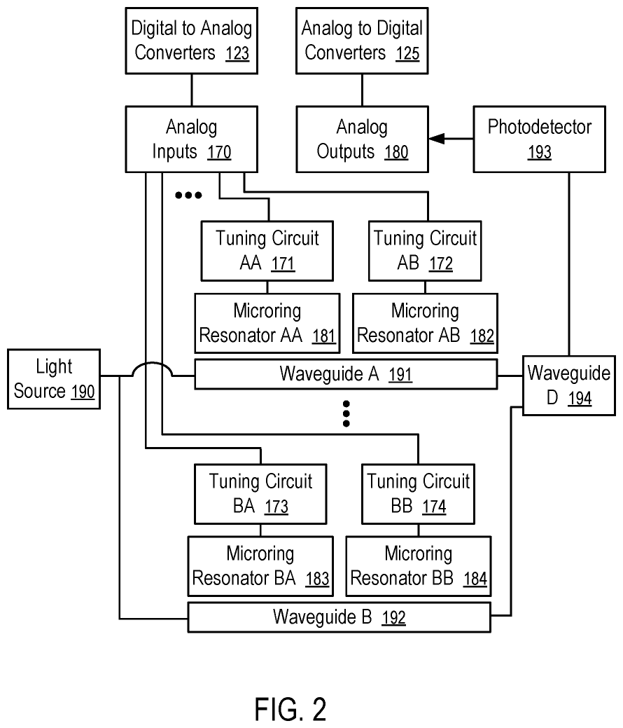

FIG. 2 shows an analog accelerator implemented using microring resonators for an attention matrix calculator according to one embodiment. For example, the analog dot product accelerator 111 of the attention matrix calculator of FIG. 1 can be implemented in a way as in FIG. 2.

In FIG. 2, digital to analog converters 123 can convert digital inputs (e.g., key elements of a key from the reordered key list 103, query elements from a row 113 of the query matrix 121) into corresponding analog inputs 170; and analog outputs 180 can be converted to digital forms via analog to digital converters 125.

The analog accelerator of FIG. 2 has microring resonators 181, 182, . . . , 183, and 184, and a light source 190 (e.g., a semiconductor laser diode, such as a vertical-cavity surface-emitting laser (VCSEL)) configured to feed light inputs into waveguides 191, . . . , 192.

Each of the waveguides (e.g., 191 or 192) is configured with multiple microring resonators (e.g., 181, 182; or 183, 184) to change the magnitude of the light going through the respective waveguide (e.g., 191 or 192).

A tuning circuit (e.g., 171, 172, 173, or 174) of a microring resonator (e.g., 181, 182, 183, or 184) can change resonance characteristics of the microring resonator (e.g., 181, 182, 183, or 184) through heat or carrier injection.

Thus, the ratio between the magnitude of the light coming out of the waveguide (e.g., 191) to enter a combining waveguide 194 and the magnitude of the light going into the waveguide (e.g., 191) near the light source 190 is representative of the multiplications of attenuation factors implemented via tuning circuits (e.g., 171 and 172) of microring resonators (e.g., 181 and 182) in electromagnetic interaction with the waveguide (e.g., 191).

The combining waveguide 194 sums the results of the multiplications performed via the lights going through the waveguides 191, . . . , 192. A photodetector 193 is configured to convert the combined optical outputs from the waveguide into analog outputs 180 in electrical domain.

For example, a set of key elements of a key from the reordered key list 103 can be applied via a portion of the analog inputs 170 connected to the tuning circuits 171, . . . , 173; and a set of query elements from a row 113 of the query matrix 121 can be applied via another portion of the analog inputs 170 connected to the tuning circuits 172, . . . , 174; and the output of the combining waveguide 194 to the photodetector 193 represents the dot product (multiplication and accumulation) between the set of key elements and the set of query elements. Analog to digital converters 125 can convert the analog outputs 180 into an output (e.g., provided to the buffer 107 of FIG. 1).

The same set of key elements as applied via the tuning circuits 171, . . . , 173 can be maintained while a set of query elements from a next row of the query matrix 121 can be applied via inputs to the tuning circuits 172, . . . , 174 to perform the dot product of the keys with the corresponding query elements of the next row. After completion of the computations involving the same set of key elements of a key, a next set of key elements of a next key can be loaded from the reordered key list 103. When the keys in the reordered list 103 are arranged in a descending order (or in an ascending order), the differences between the prior set of keys and the current set of keys fed into the tuning circuits 171, . . . , 173 are reduced or minimized, resulting reduced energy expenditure associated with state changes of the microring resonators (e.g., 181, . . . , 183) as computing elements.

Alternatively, key elements can be applied via the tuning circuits 172, . . . , 174; and query elements can be applied via the tuning circuits 171, . . . , 173.

Optionally, each of the waveguides 191, . . . , 192 can have a further microring resonator controlled by a respective tuning circuit. A scaling factor (e.g., based on a dimension size of the key list) can also be applied via the tuning circuit of the further microring resonator.

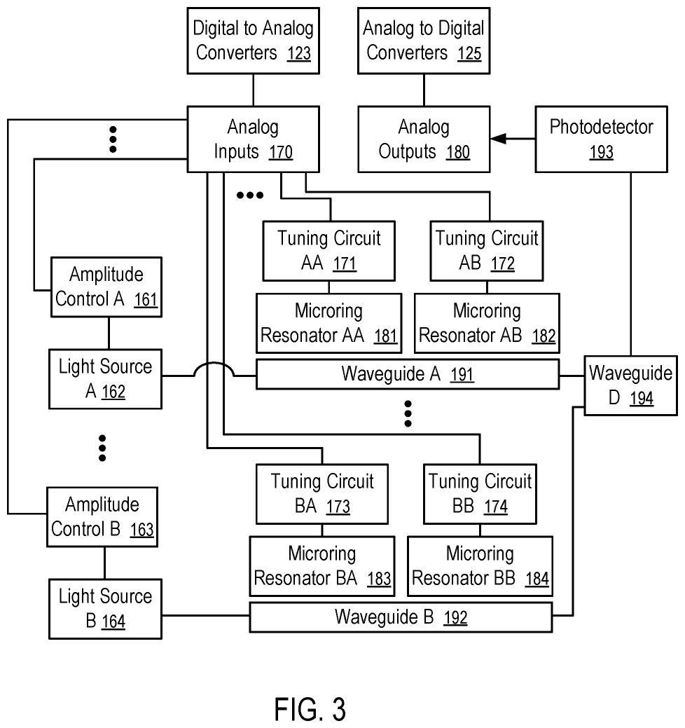

FIG. 3 shows another accelerator implemented using microring resonators for an attention matrix calculator to one embodiment. For example, the analog dot product accelerator 111 of the attention matrix calculator of FIG. 1 can be implemented in a way as in FIG. 3.

Similar to the analog accelerator of FIG. 2, the analog accelerator of FIG. 3 has microring resonators 181, 182, . . . , 183, and 184 with tuning circuits 171, 172, . . . , 173, and 174, waveguides 191, . . . , and 192, and a combining waveguide 194.

In FIG. 3, the analog accelerator has amplitude controls 161, . . . , and 163 for light sources 162, . . . , 164 connected to the waveguides 191, . . . , and 192 respectively. Thus, the amplitudes of the lights going into the waveguides 191, . . . , and 192 are controllable via a portion of the analog inputs 170 connected to the amplitude controls 161, . . . , 163. The amplitude of the light coming out of a waveguide (e.g., 191) is representative of the multiplications of the input to the amplitude control (e.g., 161) of the light source (e.g., 162) of the waveguide (e.g., 191) and the inputs to the tuning circuits (e.g., 171 and 172) of microring resonators (e.g., 181 and 182) interacting with the waveguide (e.g., 191).

For example, query elements of a query can be applied via the amplitude controls 161, . . . , 163; key elements of a key can be applied via the tuning circuits 171, . . . , 173 (or 172, . . . , 174); and a scaling factor (e.g., based on a dimension size of the key list) can also be applied via the tuning circuits 172, . . . , 174 (or 171, . . . , 173).

Optionally, microring resonators 182, 184 and their tuning circuits 172, . . . , 174 can be omitted; and the scaling factor can be applied by the processing device 109 based on an output provided by the analog accelerator in the buffer 107.

In some implementations, the digital dot product accelerator 117 in FIG. 1 is replaced with an analog accelerator of FIG. 2 or FIG. 3. For example, a set of tuning circuits (e.g., 171, . . . , and 173) can be used to apply value elements from of a segment of values from the list 105 (or a segment of the attention score 115); and another set of tuning circuits (e.g., 172, . . . , and 174) can be used to apply the segment of the attention score 115 (or the value elements of the segment of values) to generate the weighted sum of value elements; and the processing device 109 can accumulate the weighted sums across segments to obtain the attention elements of the query represented by the row 113 of the query elements from the query matrix 121. Alternatively, the value elements can be applied via the amplitude controls 161, . . . , 163; and the attention scores 115 can be applied via the tuning circuits (e.g., 171, . . . , and 173).

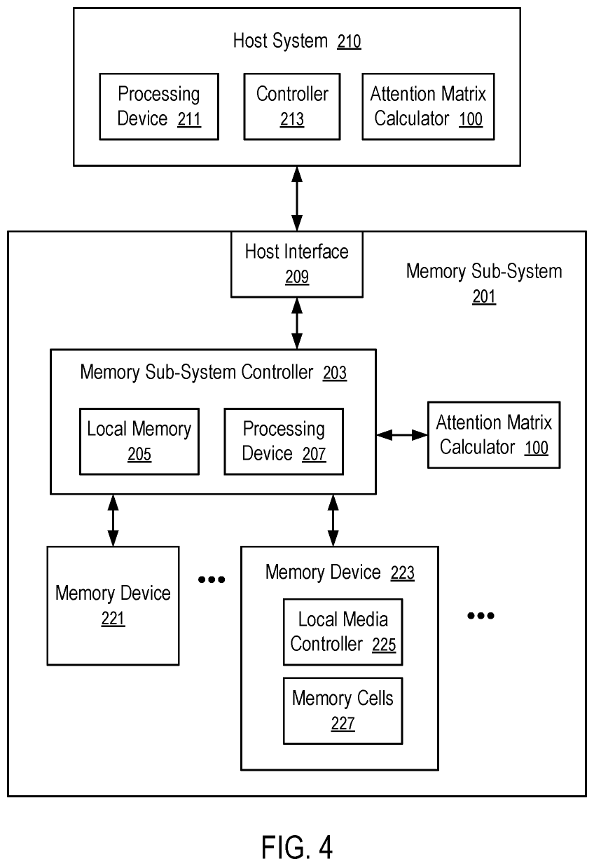

FIG. 4 shows an example computing system with an attention matrix calculator according to one embodiment.

The example computing system of FIG. 4 includes a host system 210 and a memory sub-system 201. An attention matrix calculator 100 (e.g., implemented as in FIG. 1) can be configured in the memory sub-system 201, or in the host system 210. In some implementations, a portion of the attention matrix calculator 100 (e.g., reorder buffer 127, analog dot product accelerator 111, buffer 107) is implemented in the memory sub-system 201, and another portion of the attention matrix calculator 100 (e.g., processing device 109, digital dot product accelerator 117) is implemented in the host system 210. For example, the key value pairs 101 can be stored in memory cells 227 of a memory device 223 in the memory sub-system 201; and one or more memory devices 221, . . . , 223 can be configured to implement the buffers 127 and 107 of the attention matrix calculator 100.

The memory sub-system 201 can include media, such as one or more volatile memory devices (e.g., memory device 221), one or more non-volatile memory devices (e.g., memory device 223), or a combination of such.

A memory sub-system 201 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system can include a host system 210 that is coupled to one or more memory sub-systems 201. FIG. 4 illustrates one example of a host system 210 coupled to one memory sub-system 201. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 210 can include a processor chipset (e.g., processing device 211) and a software stack executed by the processor chipset. The processor chipset can include one or more cores, one or more caches, a memory controller (e.g., controller 213) (e.g., NVDIMM controller), and a storage protocol controller (e.g., PCIe controller, SATA controller). The host system 210 uses the memory sub-system 201, for example, to write data to the memory sub-system 201 and read data from the memory sub-system 201.

The host system 210 can be coupled to the memory sub-system 201 via a physical host interface 209. Examples of a physical host interface 209 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, or any other interface. The physical host interface 209 can be used to transmit data between the host system 210 and the memory sub-system 201. The host system 210 can further utilize an NVM express (NVMe) interface to access components (e.g., memory devices 223) when the memory sub-system 201 is coupled with the host system 210 by the PCIe interface. The physical host interface 209 can provide an interface for passing control, address, data, and other signals between the memory sub-system 201 and the host system 210. FIG. 4 illustrates a memory sub-system 201 as an example. In general, the host system 210 can access multiple memory sub-systems via a same communication connection, multiple separate communication connections, and/or a combination of communication connections.

The processing device 211 of the host system 210 can be, for example, a microprocessor, a central processing unit (CPU), a processing core of a processor, an execution unit, etc. In some instances, the controller 213 can be referred to as a memory controller, a memory management unit, and/or an initiator. In one example, the controller 213 controls the communications over a bus coupled between the host system 210 and the memory sub-system 201. In general, the controller 213 can send commands or requests to the memory sub-system 201 for desired access to memory devices 223, 221. The controller 213 can further include interface circuitry to communicate with the memory sub-system 201. The interface circuitry can convert responses received from the memory sub-system 201 into information for the host system 210.

The controller 213 of the host system 210 can communicate with the controller 203 of the memory sub-system 201 to perform operations such as reading data, writing data, or erasing data at the memory devices 223, 221 and other such operations. In some instances, the controller 213 is integrated within the same package of the processing device 211. In other instances, the controller 213 is separate from the package of the processing device 211. The controller 213 and/or the processing device 211 can include hardware such as one or more integrated circuits (ICs) and/or discrete components, a buffer memory, a cache memory, or a combination thereof. The controller 213 and/or the processing device 211 can be a microcontroller, special purpose logic circuitry (e.g., a field programmable gate array (FPGA), an application specific integrated circuit (ASIC), etc.), or another suitable processor.

The memory devices 223, 221 can include any combination of the different types of non-volatile memory components and/or volatile memory components. The volatile memory devices (e.g., memory device 221) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 223 can include one or more arrays of memory cells 227. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 223 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices 223 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 223 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 203 (or controller 203 for simplicity) can communicate with the memory devices 223 to perform operations such as reading data, writing data, or erasing data at the memory devices 223 and other such operations (e.g., in response to commands scheduled on a command bus by controller 213). The controller 203 can include hardware such as one or more integrated circuits (ICs) and/or discrete components, a buffer memory, or a combination thereof. The hardware can include digital circuitry with dedicated (i.e., hard-coded) logic to perform the operations described herein. The controller 203 can be a microcontroller, special purpose logic circuitry (e.g., a field programmable gate array (FPGA), an application specific integrated circuit (ASIC), etc.), or another suitable processor.

The controller 203 can include a processing device 207 (processor) configured to execute instructions stored in a local memory 205. In the illustrated example, the local memory 205 of the controller 203 includes an embedded memory configured to store instructions for performing various processes, operations, logic flows, and routines that control operation of the memory sub-system 201, including handling communications between the memory sub-system 201 and the host system 210.

In some embodiments, the local memory 205 can include memory registers storing memory pointers, fetched data, etc. The local memory 205 can also include read-only memory (ROM) for storing micro-code. While the example memory sub-system 201 in FIG. 4 has been illustrated as including the controller 203, in another embodiment of the present disclosure, a memory sub-system 201 does not include a controller 203, and can instead rely upon external control (e.g., provided by an external host, or by a processor or controller separate from the memory sub-system).

In general, the controller 203 can receive commands or operations from the host system 210 and can convert the commands or operations into instructions or appropriate commands to achieve the desired access to the memory devices 223. The controller 203 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 223. The controller 203 can further include host interface circuitry to communicate with the host system 210 via the physical host interface. The host interface circuitry can convert the commands received from the host system into command instructions to access the memory devices 223 as well as convert responses associated with the memory devices 223 into information for the host system 210.

The memory sub-system 201 can also include additional circuitry or components that are not illustrated. In some embodiments, the memory sub-system 201 can include a cache or buffer (e.g., DRAM) and address circuitry (e.g., a row decoder and a column decoder) that can receive an address from the controller 203 and decode the address to access the memory devices 223.

In some embodiments, the memory devices 223 include local media controllers 225 that operate in conjunction with the memory sub-system controller 203 to execute operations on one or more memory cells of the memory devices 223. An external controller (e.g., memory sub-system controller 203) can externally manage the memory device 223 (e.g., perform media management operations on the memory device 223). In some embodiments, a memory device 223 is a managed memory device, which is a raw memory device combined with a local controller (e.g., local controller 225) for media management within the same memory device package. An example of a managed memory device is a managed NAND (MNAND) device.

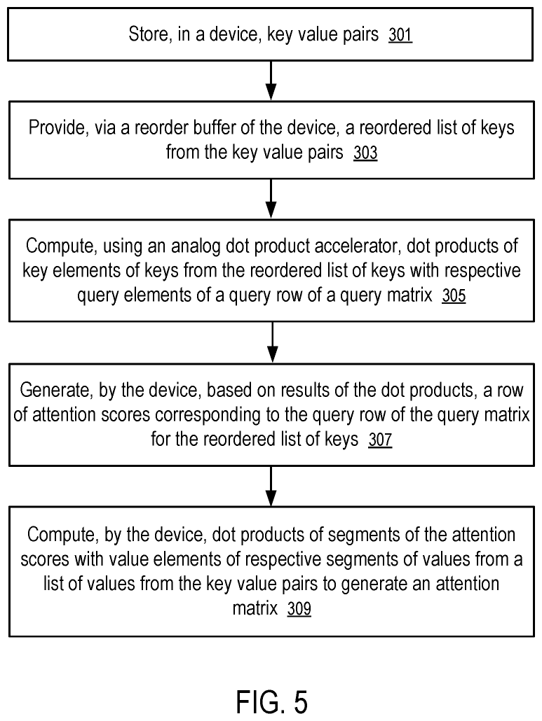

FIG. 5 shows a method to compute an attention matrix according to one embodiment. For example, the method can be implemented in a computing system or device of FIG. 4.

For example, a computing device or apparatus (e.g., as in FIG. 4) can have an attention matrix calculator 100 configured as in FIG. 1. The attention matrix calculator 100 can have an analog dot product accelerator 111 implemented via microring resonators as in FIG. 2 and FIG. 3. The processing device 109 of the attention matrix calculator 100 can be implemented via a controller 203 of the memory sub-system 201, or the processing device 211 of the host system 210, or both. Optionally, a field programmable gate array (FPGA), or an application specific integrated circuit (ASIC), can be used to implement the processing device 109 of the attention matrix calculator 100.

At block 301, the computing device (e.g., attention matrix calculator 100, memory sub-system 201 having the attention matrix calculator 100, a computing system/apparatus having the host system 210 and the memory sub-system 201) can store key value pairs 101 (e.g., in memory cells 227 of a memory device 223 in the memory sub-system 201).

To reduce energy expenditure in the analog dot product accelerator 111, the computing device can sort the keys in the key value pairs 101 into a reordered key list 103 by reducing or minimizing changes between adjacent keys to be provided sequentially as inputs to the analog dot product accelerator 111. For example, keys in the reordered key list 103 can be sorted in a descending order of keys, or an ascending order of keys.

When the computing device can use the reorder buffer 127 to provide the reordered key list 103 and the corresponding reordered value list 105.

At block 303, the computing device provides, via a reorder buffer 127, a reordered key list 103 from the key value pairs 101.

At block 305, the computing device computes, using an analog dot product accelerator 111, dot products of key elements of keys from the reordered key list 103 with respective query elements of a query row 113 of a query matrix 121.

For example, the analog dot product accelerator 111 can have: a plurality of first waveguides (e.g., 191, . . . , 192); a first plurality of microring resonators (e.g., 181, . . . , 183) configured to attenuate magnitudes of light passing through the plurality of first waveguides respectively (e.g., 191, . . . , 192); and a first plurality of tuning circuits (e.g., 171, . . . , 172) configured to change resonance characteristics of the first plurality of microring resonators (e.g., 181, . . . , 183) respectively in reduction of the magnitudes according to a first plurality of input parameters (e.g., a portion of analog inputs 170) respectively. The number of the first plurality of input parameters (e.g., a portion of analog inputs 170 connected to the tuning circuits 171, . . . , 173) that can be applied to control the first plurality of tuning circuits (e.g., 171, . . . , 173) can be equal to, or larger than, the total number of key elements of a key in the reordered key list 103 (and the key value pairs 101). Thus, the computing device (e.g., attention matrix calculator 100, memory sub-system 201 having the attention matrix calculator 100, a computing system/apparatus having the host system 210 and the memory sub-system 201) is configured to apply the key elements of the key as the first plurality of input parameters (e.g., a portion of analog inputs 170 connected to the tuning circuits 171, . . . , 173) to the first plurality of tuning circuits (e.g., 171, . . . , 173) in computations of the dot products.

The analog dot product accelerator 111 can further include: a second waveguide (e.g., 194) configured to combine light from the plurality of first waveguides (e.g., 191, . . . , 192); and a photodetector (e.g., 193) configured to measure a magnitude of light from the second waveguide (e.g., 194). The magnitude is representative of the sum of the results of multiplications performed via the plurality of first waveguides (e.g., 191, . . . , 192).

Optionally, the analog dot product accelerator 111 can be configured to scale the dot products according to a scaling factor (e.g., based on a square root of a dimension size, such as a size of the keys or values in the key value pairs 101, or a size of the query matrix 121).

For example, the analog dot product accelerator 111 can further include: a second plurality of microring resonators (e.g., 182, . . . , 184) configured to attenuate magnitudes of light passing through the plurality of first waveguides (e.g., 191, . . . , 192) respectively; and a second plurality of tuning circuits (e.g., 172, . . . , 174) configured to change resonance characteristics of the second plurality of microring resonators (e.g., 182, . . . , 184) according to a second plurality of input parameters (e.g., a portion of inputs 170 connected to the tuning circuits 172, . . . , 174) respectively. The computing device can be configured to apply a same scaling factor as the second plurality of input parameters in the computations of the dot products.

Optionally, the analog dot product accelerator 111 can include: a plurality of light sources (e.g., 162, . . . , 164) configured to provide light into the plurality of first waveguides (e.g., 191, . . . , 192) respectively; and a plurality of amplitude controls (e.g., 161, . . . , 162) configured to adjust amplitudes of light generated by the plurality of light sources (e.g., 162, . . . , 164) according to a third plurality of input parameters (e.g., a portion of the inputs 170 connected to the amplitude controls 161, . . . , 163) respectively. The computing device can be configured to apply query elements of a row 113 of the query matrix 121 as the third plurality of input parameters to the plurality of amplitude controls (e.g., 161, . . . , 163) in the computations of the dot products. Alternatively, the query elements of the row 113 of the query matrix 121 can be applied via a set of microring resonators (e.g., 182, . . . , 184).

At block 307, the computing device generates, based on results of the dot products, a row of attention scores 115 corresponding to the query row 113 of the query matrix 121 for the reordered key list 103.

The computing device can be configured to repeat dot product computations involving a same key for different rows of the query matrix before replacing the key elements of the key with the key elements of a next key from the reordered key list 103 as the first plurality of input parameters (e.g., a portion of analog inputs 170 connected to the tuning circuits 171, . . . , 173) to the first plurality of tuning circuits (e.g., 171, . . . , 173).

The computing device can repeat dot product computations for different keys from the reordered key list 103 to generate similarity scores of a query row (e.g., 113) with respective keys in the key list 103. The similarity scores can be transformed (e.g., via an exponential function as in softmax) and normalized (e.g., via a softmax function) to generate a row of attention scores 115.

At block 309, the computing device computes dot products of segments of the attention scores 115 with value elements of respective segments of values from a value list 105 from the key value pairs 101 to generate an attention matrix 119.

For example, the computing device can include a digital dot product accelerator 117 having a plurality of logic circuits configured to perform multiplication and accumulation operations in parallel.

Alternatively, an analog accelerator can be used. For example, the analog accelerator can have a plurality of light sources 162, . . . , 164 with amplitude controls 161, . . . , 163 to apply value elements of a segment of values from the value list 105, and a plurality of tuning circuits 171, . . . , 173 to apply a segment of the attention score 115 to control microring resonators 181, . . . , 183 in attenuating lights provided by the light sources 162, . . . , 164 into waveguides 191, . . . , 192. The result of the dot product for the segment of values can be accumulated across segments of values in the reordered value list 105 to obtain a measure of attention in the attention matrix 119. A same segment of the attention score 115 can be maintained for the computations of different components of a same segment of values. Alternatively, both value elements and attention scores can be applied via microring resonators (e.g., 181, . . . , 183; and 182, . . . , 184).

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus, comprising:
memory configured to store key value pairs;
a reorder buffer configured to provide a reordered list of keys from the key value pairs;
an analog dot product accelerator configured to compute dot products of key elements of keys from the reordered list of keys with respective query elements of a query row of a query matrix;
a processing device configured to generate, based on results of the dot products, a row of attention scores corresponding to the query row of the query matrix for the reordered list of keys; and
a further accelerator configured to compute dot products of segments of the attention scores with value elements of respective segments of values from a list of values from the key value pairs to generate an attention matrix.

2. The apparatus of claim 1, wherein the further accelerator comprises a plurality of logic circuits configured to perform multiplication and accumulation operations in parallel.

3. The apparatus of claim 1, wherein the reordered list of keys is in a descending order of keys, or an ascending order of keys.

4. The apparatus of claim 1, wherein the reorder buffer is further configured to provide the list of values in an order corresponding to an order of keys in the reordered list of keys.

5. The apparatus of claim 1, wherein the analog dot product accelerator includes:
a plurality of first waveguides;
a first plurality of microring resonators configured to attenuate magnitudes of light passing through the plurality of first waveguides respectively; and
a first plurality of tuning circuits configured to change resonance characteristics of the first plurality of microring resonators respectively in reduction of the magnitudes according to a first plurality of input parameters respectively;
wherein the processing device is configured to apply key elements of a key as the first plurality of input parameters to the first plurality of tuning circuits in computations of the dot products.

6. The apparatus of claim 5, wherein the analog dot product accelerator includes:
a second waveguide configured to combine light from the plurality of first waveguides; and
a photodetector configured to measure a magnitude of light from the second waveguide.

7. The apparatus of claim 6, wherein the analog dot product accelerator further includes:
a second plurality of microring resonators configured to attenuate magnitudes of light passing through the plurality of first waveguides respectively; and
a second plurality of tuning circuits configured to change resonance characteristics of the second plurality of microring resonators according to a second plurality of input parameters respectively;
wherein the device is configured to apply a same scaling factor as the second plurality of input parameters in the computations of the dot products.

8. The apparatus of claim 7, wherein the scaling factor is based on a dimension size of keys in the key value pairs.

9. The apparatus of claim 7, wherein the analog dot product accelerator further includes:
a plurality of light sources configured to provide light into the plurality of first waveguides respectively; and
a plurality of amplitude controls configured to adjust amplitudes of light generated by the plurality of light sources according to a third plurality of input parameters respectively;
wherein the device is configured to apply query elements of a row of the query matrix as the third plurality of input parameters to the plurality of amplitude controls in the computations of the dot products.

10. The apparatus of claim 9, wherein the device is configured to repeat dot product computations involving a same current key for different rows of the query matrix before replacing the current key with a next key from the reordered list of keys as the first plurality of input parameters to the first plurality of tuning circuits.

11. The apparatus of claim 6, wherein the analog dot product accelerator further includes:
a second plurality of microring resonators configured to attenuate magnitudes of light passing through the plurality of first waveguides respectively; and
a second plurality of tuning circuits configured to change resonance characteristics of the second plurality of microring resonators according to a second plurality of input parameters respectively;
wherein the device is configured to apply query elements of a row of the query matrix as the second plurality of input parameters to the second plurality of tuning circuits in the computations of the dot products.

12. A method, comprising:
storing, in a device, key value pairs;
providing, via a reorder buffer of the device, a reordered list of keys from the key value pairs;
computing, using an analog dot product accelerator, dot products of key elements of keys from the reordered list of keys with respective query elements of a query row of a query matrix;
generating, by the device, based on results of the dot products, a row of attention scores corresponding to the query row of the query matrix for the reordered list of keys; and
computing, by the device, dot products of segments of the attention scores with value elements of respective segments of values from a list of values from the key value pairs to generate an attention matrix.

13. The method of claim 12, further comprising:
sorting, by the device, keys in the key value pairs, into the reordered list of keys to reduce or minimize changes between adjacent keys provided sequentially as inputs to the analog dot product accelerator;
wherein keys in the reordered list of keys are in a descending order of keys, or an ascending order of keys.

14. The method of claim 12, wherein the analog dot product accelerator includes:
a plurality of first waveguides;
a first plurality of microring resonators configured to attenuate magnitudes of light passing through the plurality of first waveguides respectively;
a first plurality of tuning circuits configured to change resonance characteristics of the first plurality of microring resonators respectively in reduction of the magnitudes according to a first plurality of input parameters respectively;
a second waveguide configured to combine light from the plurality of first waveguides; and
a photodetector configured to measure a magnitude of light from the second waveguide;
wherein the method further comprises applying key elements of a key as the first plurality of input parameters to the first plurality of tuning circuits in computations of the dot products.

15. The method of claim 14, wherein the analog dot product accelerator further includes:
a second plurality of microring resonators configured to attenuate magnitudes of light passing through the plurality of first waveguides respectively; and
a second plurality of tuning circuits configured to change resonance characteristics of the second plurality of microring resonators according to a second plurality of input parameters respectively;
wherein the method further comprises applying a same scaling factor as the second plurality of input parameters in the computations of the dot products; and
wherein the scaling factor is based on a dimension size of keys in the key value pairs.

16. The method of claim 15, wherein the analog dot product accelerator further includes:
a plurality of light sources configured to provide light into the plurality of first waveguides respectively; and
a plurality of amplitude controls configured to adjust amplitudes of light generated by the plurality of light sources according to a third plurality of input parameters respectively;
wherein the method further comprises:
applying query elements of a row of the query matrix as the third plurality of input parameters to the plurality of amplitude controls in the computations of the dot products; and
repeating, in the analog dot product accelerator, dot product computations involving a same current key for different rows of the query matrix before replacing the current key with a next key from the reordered list of keys as the first plurality of input parameters to the first plurality of tuning circuits.

17. The method of claim 14, wherein the analog dot product accelerator further includes:
a second plurality of microring resonators configured to attenuate magnitudes of light passing through the plurality of first waveguides respectively; and
a second plurality of tuning circuits configured to change resonance characteristics of the second plurality of microring resonators according to a second plurality of input parameters respectively;
wherein the method further comprises applying query elements of a row of the query matrix as the second plurality of input parameters to the second plurality of tuning circuits in the computations of the dot products.

18. A non-transitory computer storage medium storing instructions which, when executed in a computing device, cause the computing device to perform a method, comprising:
sorting keys of key value pairs into a reordered list of keys;
computing, using an analog dot product accelerator, dot products of key elements of keys from the reordered list of keys with respective query elements of a query row of a query matrix;
generating, based on results of the dot products, a row of attention scores corresponding to the query row of the query matrix for the reordered list of keys; and
computing dot products of segments of the attention scores with value elements of respective segments of values from a list of values from the key value pairs to generate an attention matrix.

19. The non-transitory computer storage medium of claim 18, wherein keys in the reordered list of keys are in a descending order of keys, or an ascending order of keys.

20. The non-transitory computer storage medium of claim 19, wherein the analog dot product accelerator includes microring resonators; and the method further comprises:
providing keys from the reordered list of keys to control operations of the microring resonators in performing computations of the dot products in optical domain.
